(19) United States
(12) Patent Application Publication
(10) Pub. No.: US 2021/0218741 A1
(43) Pub. Date: Jul. 15, 2021

(54) ACCESS MANAGEMENT TO SERVICE FACILITIES AND PRESENCE TRACKING

(71) Applicant: FlexIt Inc., New York, NY (US)

(72) Inventor: Austin Cohen, New York, NY (US)

(21) Appl. No.: 17/035,009

(22) Filed: Sep. 28, 2020

Related U.S. Application Data
(60) Provisional application No. 62/906,281, filed on Sep. 26, 2019.

(51) Int. Cl. H04L 29/06

(52) U.S. Cl. CPC H04L 63/0876; H04L 63/107; H04L 63/102; H04L 63/0492

(57) ABSTRACT

A method and system for managing facility access and user presence tracking, the system comprising a facilities management server configured to authenticate a client device over a communications network, the client device initiating the authentication by scanning a scan code at a terminal of a facility and transmit instructions to the terminal to check-in a user of the client device and allow the user access to the facility.

### CROSS REFERENCE TO RELATED APPLICATION

This application claims the priority of U.S. Provisional Application No. 62/906,281, entitled “ACCESS MANAGEMENT TO SERVICE FACILITIES AND PRESENCE TRACKING,” filed on Sep. 26, 2019, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to accessing facilities, and in particular, managing access to different service facilities through requests from user client devices.

### Description of the Related Art

Many commercial facilities like fitness centers issue membership cards to their customers. With a membership card, a customer can use the services of or buy products from the card issuing facility. A fitness center may issue membership cards to individual members, which store information electronically for member identification and attendance management for each of the registered members. When a member arrives at the fitness center, he/she must present their membership card for scanning by a card reader upon to verify member identification and attendance.

Such conventional member identification and attendance systems have various drawbacks including the need to carry and manage a plurality of membership cards. It is inconvenient for members, who need to visit the visit the fitness center but does not carry a membership card with him/her. There are also inconveniences in that the member must carry multiple membership cards for each facility that the member signed up for. Another drawback includes the confinement of members to certain facilities where members are not able to access facilities that are not covered under a current membership. This prohibits flexibility to members who may travel or desire to have the flexibility of using different facilities.

Thus, there is a need to provide systems and methods that enable members to be able to access any nearby or desired facility without carrying a given membership card.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates an exemplary facility locator client device interface according to an embodiment of the present invention.

FIG. 3 illustrates a facility detail page according to an embodiment of the present invention.

FIG. 4 illustrates a computing system according to an embodiment of the present invention.

FIG. 5 illustrates exemplary terminal hardware according to an embodiment of the present invention.

FIG. 6 illustrates an exemplary check-in feature of an administrator interface according to an embodiment of the present invention.

FIGS. 7 through 9 illustrate an exemplary guest viewing feature of an administrator interface according to an embodiment of the present invention.

FIGS. 10 and 11 illustrate an exemplary geo-fence feature according to an embodiment of the present invention.

FIG. 12 illustrates an exemplary guest history feature of an administrator interface according to an embodiment of the present invention.

FIGS. 13 and 14 illustrate exemplary analytics information provided by an administrator interface according to an embodiment of the present invention.

FIG. 15 illustrates an exemplary in-session client device interface according to an embodiment of the present invention.

FIG. 16 illustrates an exemplary session review client device interface according to an embodiment of the present invention.

FIG. 17 illustrates an exemplary screen flow of a wallet client device interface according to an embodiment of the present invention.

FIG. 18 illustrates an exemplary screen flow of a promotion redemption according to an embodiment of the present invention.

FIG. 19 illustrates exemplary personal training interfaces according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Systems and methods are disclosed for locating and gaining access to service facilities, such as a fitness center, yoga studio, spa, and the like. The disclosed systems and methods may also be applied to other industries that may have unused inventory. User client devices may communicate with a facilities management system via an interface that searches for service facilities based on a specified or determined location and provides details of the service facilities. Access to given service facilities may be granted to users on-demand via an interface with a facilities management system. The facilities management system may further track and monitor user presence and/or utilization of service facilities via communication over a network with the user client devices.

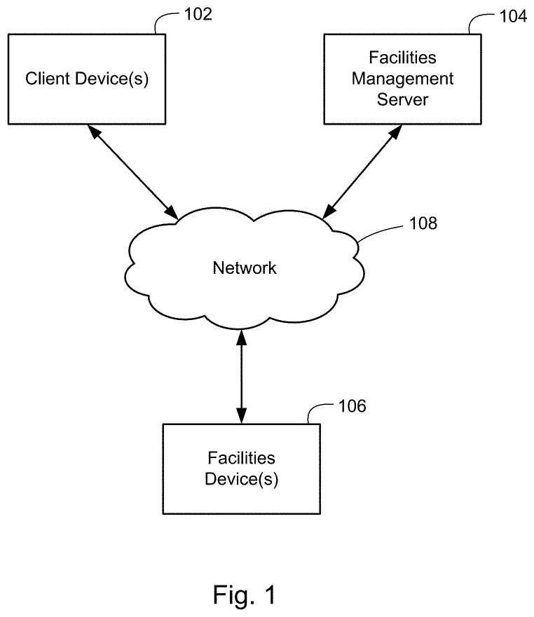

FIG. 1 illustrates a computing system according to an embodiment of the present invention. The system presented in FIG. 1 includes client device(s) 102, facilities management server 104, client device 106, and network 108. Client device(s) 102 may comprise computing devices (e.g., desktop computers, television devices, terminals, laptops, personal digital assistants (PDA), cellular phones, smartphones, tablet computers, e-book readers, smart watches and smart wearable devices, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display.

A client device may also include or execute an application to communicate content, such as, for example, textual content, multimedia content, or the like. Communications and content stored and/or transmitted to and from client device(s) 102 may be encrypted using, for example, the Advanced Encryption Standard (AES) with a 128, 192, or 256-bit key size, or any other encryption standard known in the art. A client device may include or execute a variety of operating systems, including a personal computer operating system, such as a Windows, Mac OS or Linux, or a mobile operating system, such as iOS, Android, or Windows Phone, or the like. A client device may further include or execute a variety of possible applications, such as a client software application enabling communication with other devices, such as communicating one or more messages, such as via email, short message service (SMS), or multimedia message service (MMS), including via a network, as well as a social network, including, for example, Facebook, LinkedIn, Twitter, Pinterest, Snapchat, or Instagram, to provide only a few possible examples.

Facilities device(s) 106 may also comprise computing devices similar to client device(s) 102. The facilities devices(s) 106 may communicate over network 108 to register a service facility with facilities management server 104. The service facility may be added to a network of service facilities that is managed by facilities management server 104. The network of service facilities may comprise a collection of service facilities that may be offered access to its premises through facilities management server 104. Registering a service facility to the network of facilities may include the facilities device(s) 106 transmitting information associated with one or more service facilities to facilities management server 104. The information may include location, pricing, offers, amenities, photographs, schedule, contact information, social media information, etc. The information may be stored and updated in a database accessible by facilities management server 104.

Facilities management server 104 may comprise one or more processing components disposed on one or more processing devices or systems in a networked environment. For example, the facilities management server 104 may be comprised of at least a special-purpose digital computing device including at least one or more central processing units and memory. The facilities management server 104 may also include one or more of mass storage devices, power supplies, wired or wireless network interfaces, input/output interfaces, and operating systems, such as Windows Server, Mac OS X, Unix, Linux, FreeBSD, or the like. In an example embodiment, facilities management server 104 may include or have access to memory for storing instructions or applications for the performance of various functions and a corresponding processor for executing stored instructions or applications. For example, the memory may store an instance of the facilities management server 104 configured to operate in accordance with the disclosed embodiments.

Network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof.

Client device(s) 102 may access the network of service facilities by communicating with facilities management server 104 over network 108. The client device(s) 102 may register or create an account to allow the client device(s) 102 to access the network of service facilities. According to another embodiment, client device(s) 102 may use an existing account, such as a user's social networking account, to sign on to facilities management server 104. Facilities management server 104 is operative to receive location-based search requests (e.g., facility locator) from client device(s) 102 and process the requests to generate responses (facility listings) to the client device(s) 102 across the network 108.

The facilities management server 104 may provision any service facility from the network of service facilities for on-demand access by users of client device(s) 102 at dynamically changing short-term rates (e.g., by-the-minute). Conventional membership to service facilities with longer terms may offer a lower price per service or product charged to the user, in an attempt to entice purchasers to lengthen their purchase commitments. However, these memberships require a fixed payment for a fixed period of time without the ability of a member to obtain the return of any portion of the payment in the event that the member should desire to terminate the membership prior to the end of the fixed time period for which the fee has been paid. Individuals may find it difficult to use the membership adequately in order to get their money's worth. Members may also find that they no longer have the time or opportunity to use the product or service due to a change in work responsibility, change in employment location, change in residence or lifestyle, etc., but are locked in the membership during which the product or service is no longer used. As such, the disclosed systems and methods alleviate such angst by providing flexible access to services facilities.

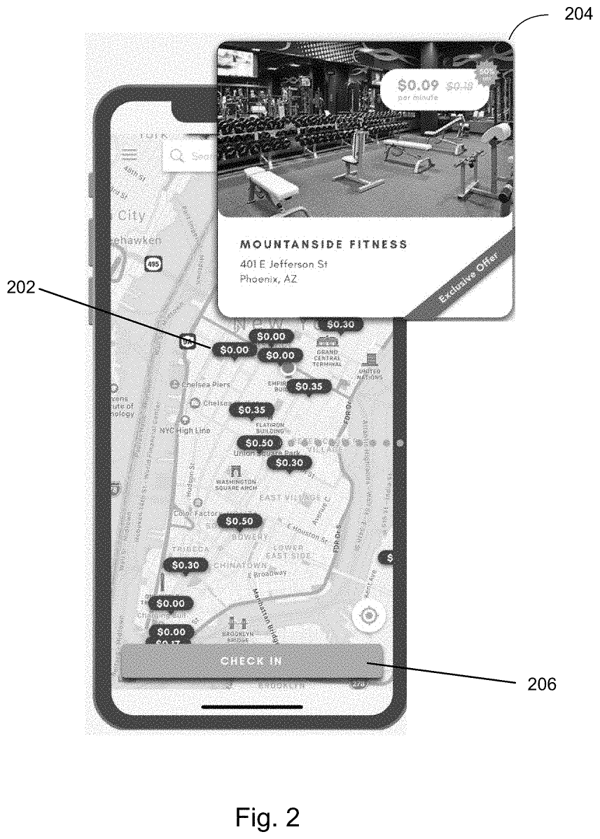

FIG. 2 presents an exemplary facility locator interface according to an embodiment of the present invention. A facility locator interface may be provided by a facilities management server and rendered on a client device. The facility locator interface may include a map view that allows a user of the client device to perform a location-based search for service facilities or to plan future facility visits in different regions. Search results of nearby facilities may be presented on the map view with each facility displaying a current rate 202. The displayed current rate 202 may be presented according to a configurable rate duration, such as by-the-minute, hourly, or daily. A given facility may be selected to present an interactive facility card 204 which may present more expansive facility details. For example, interactive facility card 204 may include discounts, dynamic pricing changes, exclusive offers, and facility photos. The facility locator interface may also include a “check in” button 206 to request access to a selected facility.

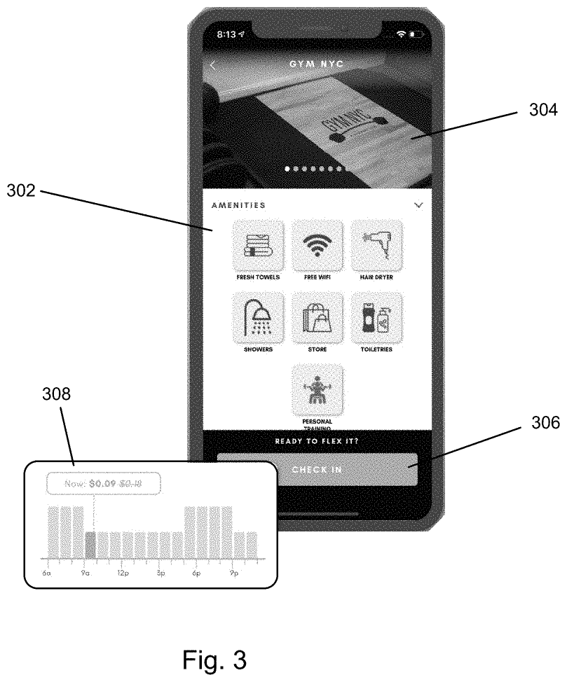

Users may also select the interactive facility card 204 to direct or navigate them to a facility detail page, as illustrated in FIG. 3 according to an embodiment of the present invention. The facility detail page may include amenities 302 and images 304. Amenities 302 may include depictions of accessible amenities available to users. Images 304 may include gym photography and depictions of the displayed facility that are synchronized to the facility detail page. According to one embodiment, the facility detail page may also provide a rate chart 308. The rate chart 308 may present facility rates that dynamically vary on a day-by-day or hour-by-hour basis. Changes to the facility rates may be visible for present and future visits. The facility detail page may also include a “check in” button 306 to request access to the displayed facility.

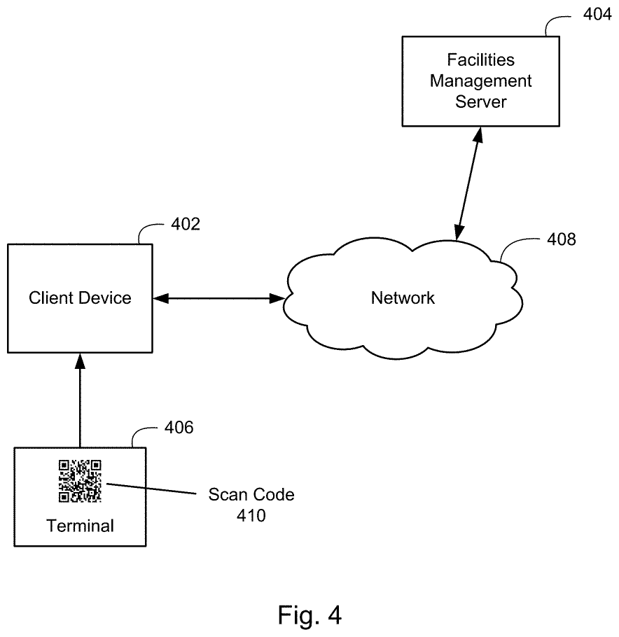

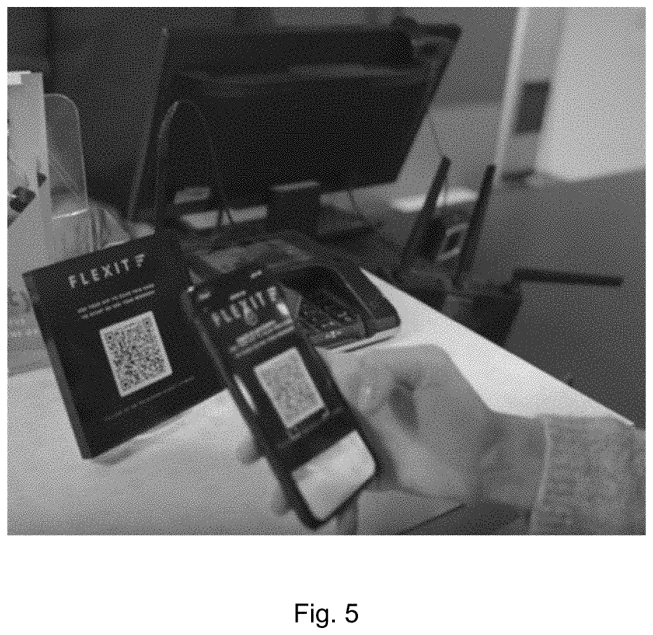

FIG. 4 presents a computing system for managing facility access and user presence tracking according to an embodiment of the present invention. A terminal 406 may be configured at a facility. Client device 402 may be used to authenticate a user to gain access to the facility. The client device 402 may comprise a computing device including and executing application software that causes a processor to use a camera and/or scanning device to scan or receive a scan code 410 from terminal 406. Terminal 406 may comprise a computing device including a mounted display and/or hardware device capable of presenting scan code 410 to client device 402, as illustrated in FIG. 5. Scan code 410 may include a barcode, such as a quick response code (“QR code”), a matrix barcode, linear barcode. In other embodiments, the scan code 410 may be provided as a radio frequency identification (“RFID”) tag or a near-field communications (“NFC”) tag.

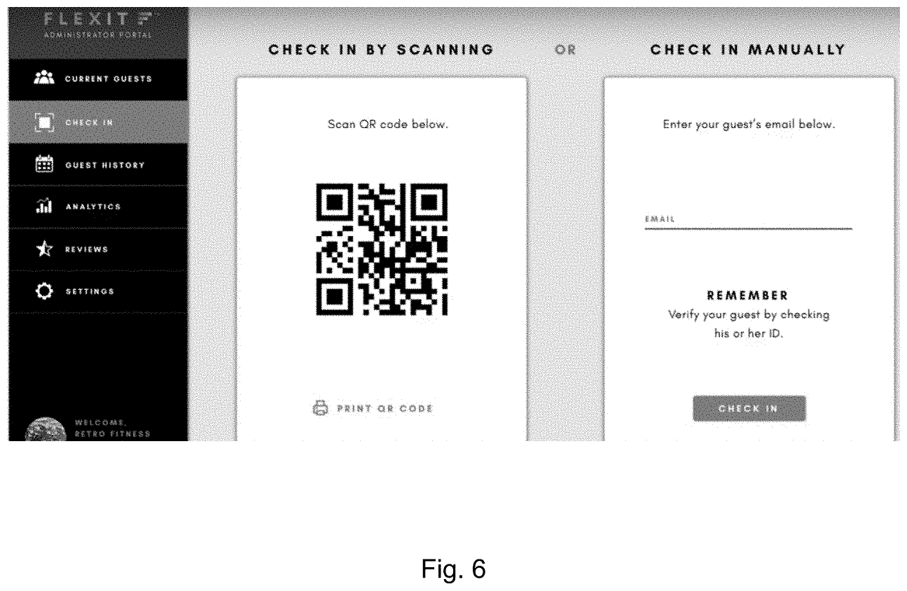

Scanning the scan code 410 by client device 402 may cause client device 402 to initiate an authentication process with facilities management server 404 over network 408. Authentication may include the facilities management server 404 verifying an account and credentials provided from the client device 402. A successful authentication of the client device 402 may cause facilities management server 404 to communicate instructions over network 408 to terminal 406 to “check-in” the user of the client device 402 and allow the user to access the facility. Terminal 406 may also be capable of manually authenticating and checking-in the user by, for example, entering an email address or any other identifying information (e.g., FIG. 6).

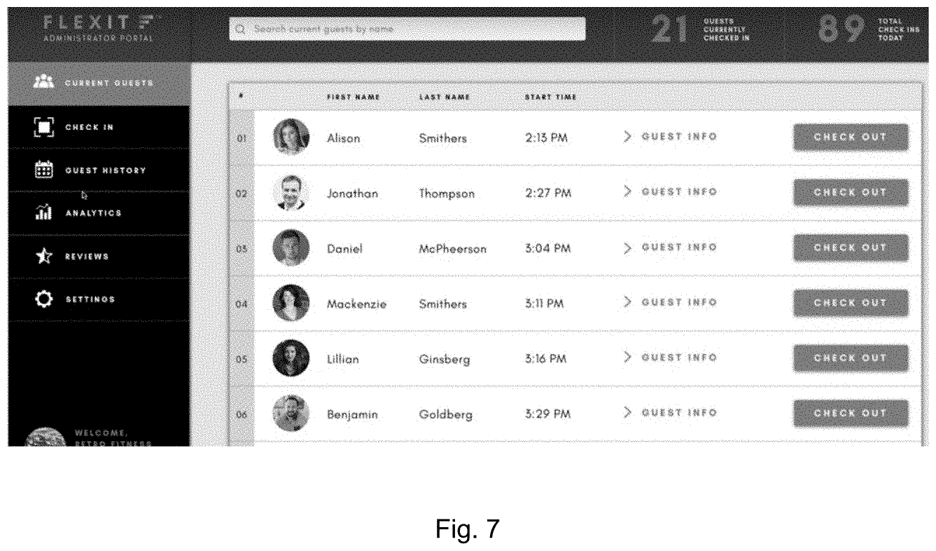

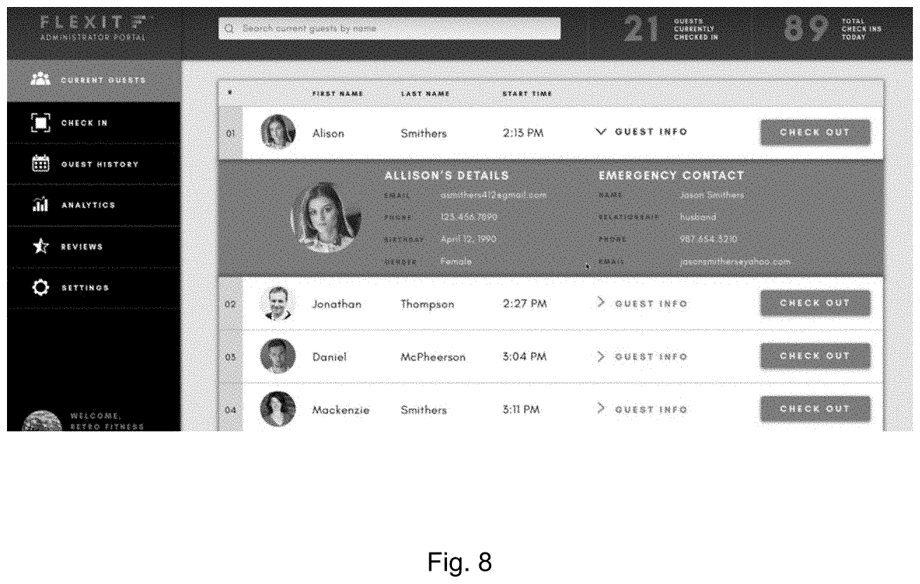

Checking-in a user may include activation of presence tracking of the user and facility access duration. Terminal 406 may be able to view and search for current guests by name that have checked-in at the facility by using an administrator interface, such as the one illustrated in FIG. 7. The administrator interface may also display a count of guests currently checked-in and total check-ins for the day. Information of each guest may be viewable on the interface. FIG. 8 presents viewable information corresponding to guests in an exemplary administration interface. The viewable information may include email address, phone number, birthday, and gender of the guest. Emergency contact information including name, relationship, phone number, and email address of an emergency contact may also be included in the viewable information.

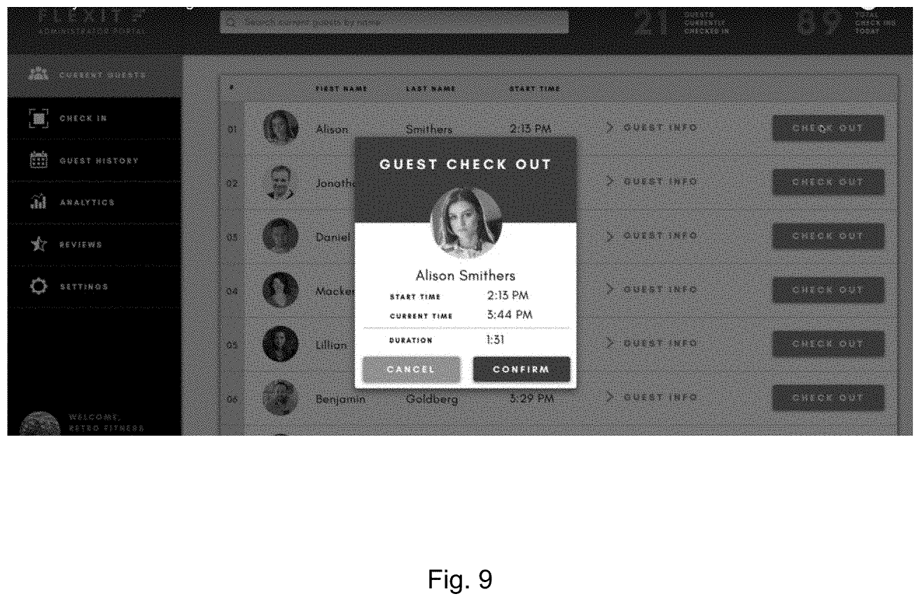

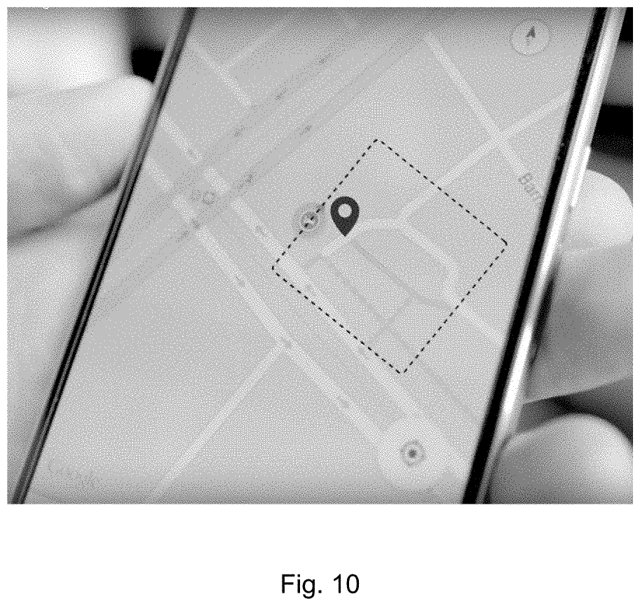

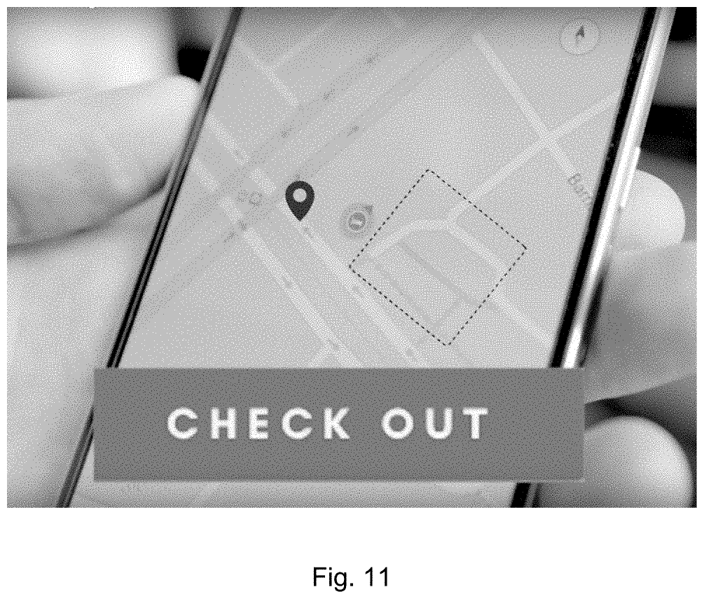

A user may “check-out,” end a facility access session, or indicate a departure from the facility by indicating such using client device 402. The client device 402 may then communicate with facilities management server 404 to terminate the session and access to the facility. The facilities management server 404 may also communicate the check-out with terminal 406. Terminal 406 may additionally confirm the check-out through the administrator interface (FIG. 9). According to another embodiment, a geo-fence may be configured with the client device 402 and activated upon checking-in to the facility. The geo-fence may include a monitoring of a physical location of the client device 402 by using GPS, RFID, Wi-Fi, or cellular data to automatically trigger a check-out action that is communicated to the facilities management server 404 when client device 402 exits a virtual boundary configured around the premises of the facility, as illustrated in FIG. 10 and FIG. 11.

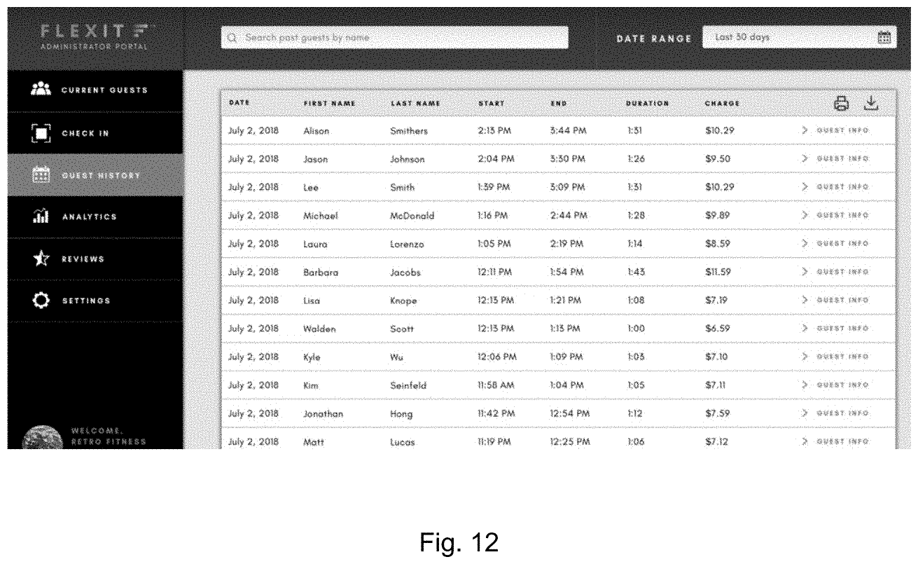

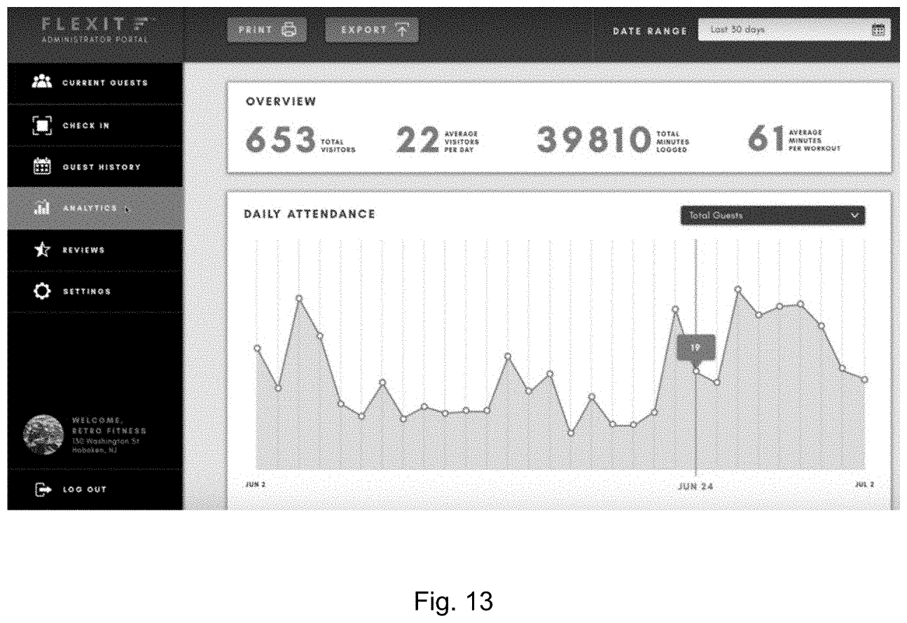

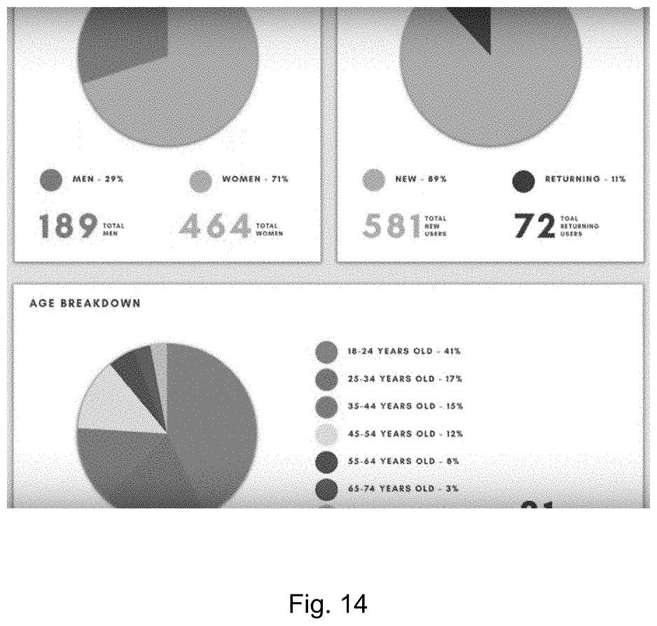

The administrator interface may also be used to view a “guest history,” for example, as shown by FIG. 12. Information, such as date, name, start time, end time, duration, and charge may be recorded for each guest by facilities management server 404 and viewed at terminal 406. FIG. 13 presents an exemplary view that presents analytics information according to an embodiment of the present invention. The analytics information may include graphs and statistics of daily attendance over a period of time, total visitors, average visitors per day, total minutes logged by guests, and average minutes per workout/visit. FIG. 14 presents additional analytics information that may be presented including graphs and statistics of gender, new and returning users, and guest age breakdown.

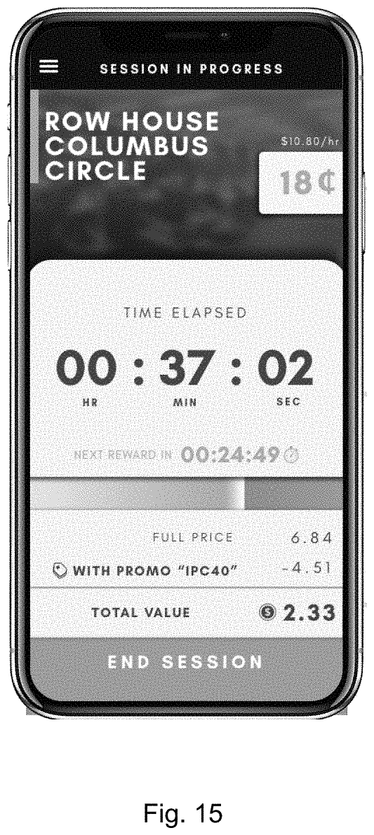

FIG. 15 presents an exemplary in-session client device interface according to an embodiment of the present invention. A client device that has checked in with a facility may generate a “session in progress” screen. The “session in progress” screen may include an identification of a facility, a current facility rate, and a time card of a current facility access session. The time card may include a time elapsed that displays an active time and a reward breakdown. The reward breakdown may include a promotional value and dynamic rate discounting that is applied to the current session. The “session in progress” screen may also be used to end a session at the facility.

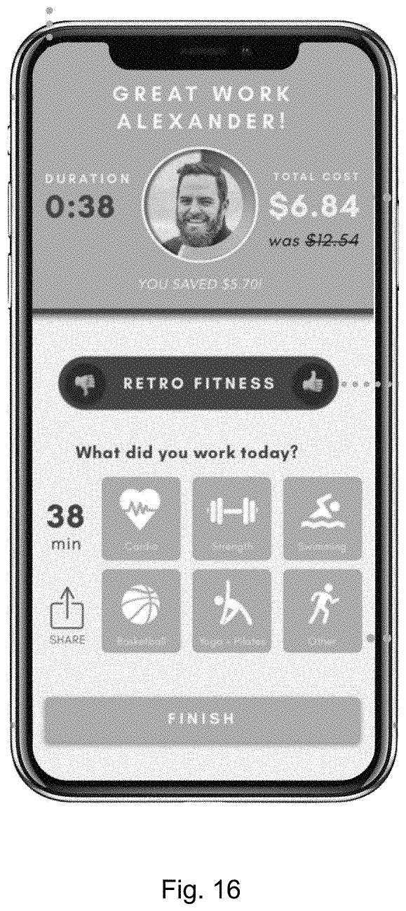

FIG. 16 presents an exemplary session review client device interface according to an embodiment of the present invention. A session review interface may be generated for display on a client device after ending a session at a facility. The session review interface may include a personalized post-workout screen with a focus on the user including a cost breakdown and a time-based workout breakdown, along with savings from applied discounts. A rewards progress circle surrounding a profile image of a user may also be displayed to indicate time remaining until a next workout to incentivize subsequent workouts.

The session review interface may also include a facility review component that allows the user to rate the facility. The facility review component may comprise an internal reviewing system that allows trackable data stored to log and tracks facility preferences. Information collected by the facility review component may allow internal reporting on facility visits to recognize top facilities. Amenities used by the user may be tracked and stored as according to each user and for each facility. Time spent by workout breakdown may be striated to capture precise reports of number of minutes spent by a user doing any/all of user-indicated activities. Such data can be used to inform targeted marketing to given users with specific fitness interests. Data meta-analyses are able to conceptualize the experience that users as a whole seek from their facility experience.

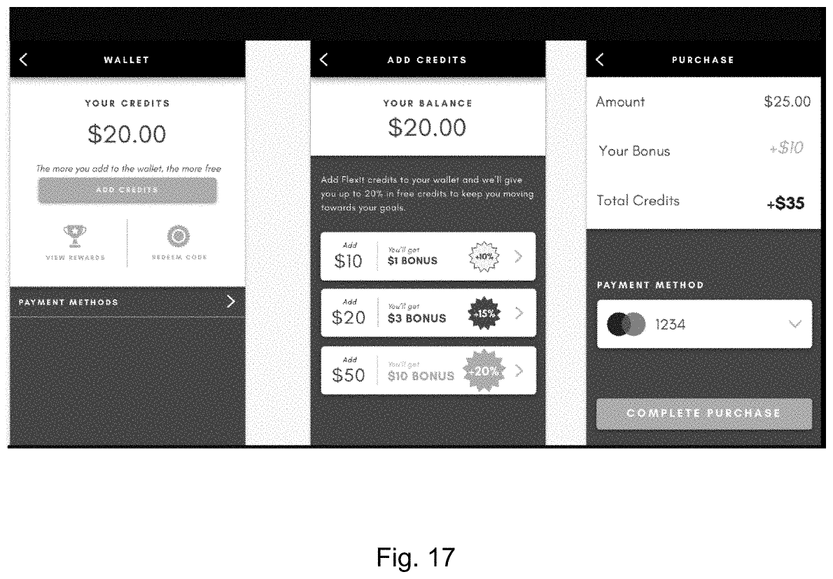

FIG. 17 presents an exemplary screen flow of a wallet client device interface according to an embodiment of the present invention. A wallet client device interface may comprise an “in-app wallet” that may be used to add monetary credits to balance to pay for sessions. Credits may be added in certain increments or a value specified by the user of the client device. According to one embodiment, bonuses may be awarded to users for adding certain predetermined amounts. To add credits, the user may choose a payment method, such as a credit card, checking account, a third-party electronic payment system, such as Stripe or PayPal, Apple Pay, or Google Wallet, cryptocurrency, or any other method of payment.

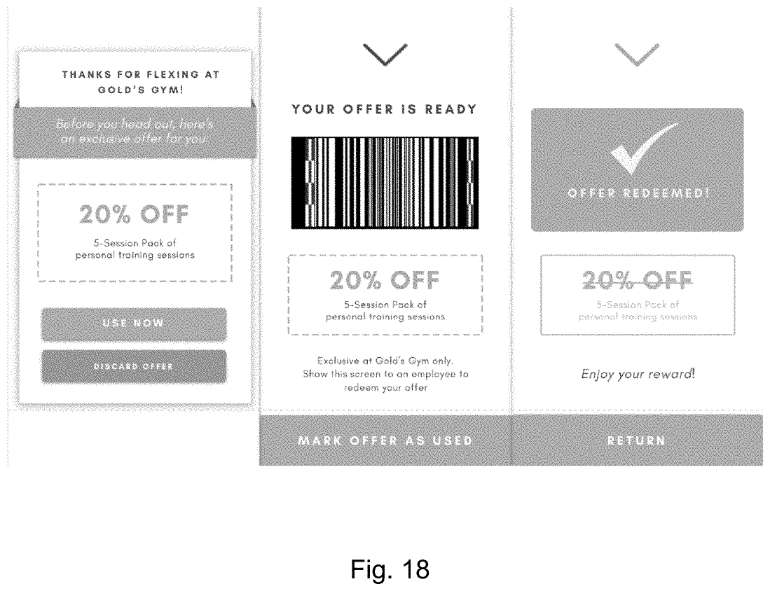

FIG. 18 presents an exemplary screen flow of a promotion redemption according to an embodiment of the present invention. Promotional pop-ups may be presented from the facilities management server to a client device in certain instances, such as after an end of a session, periodically for given facilities (e.g., a loyalty program, member retention, etc.), new facility openings, or any other promotional opportunities. A promotional pop-up may generate a code that may be scanned at a specified facility and applied to the user's account.

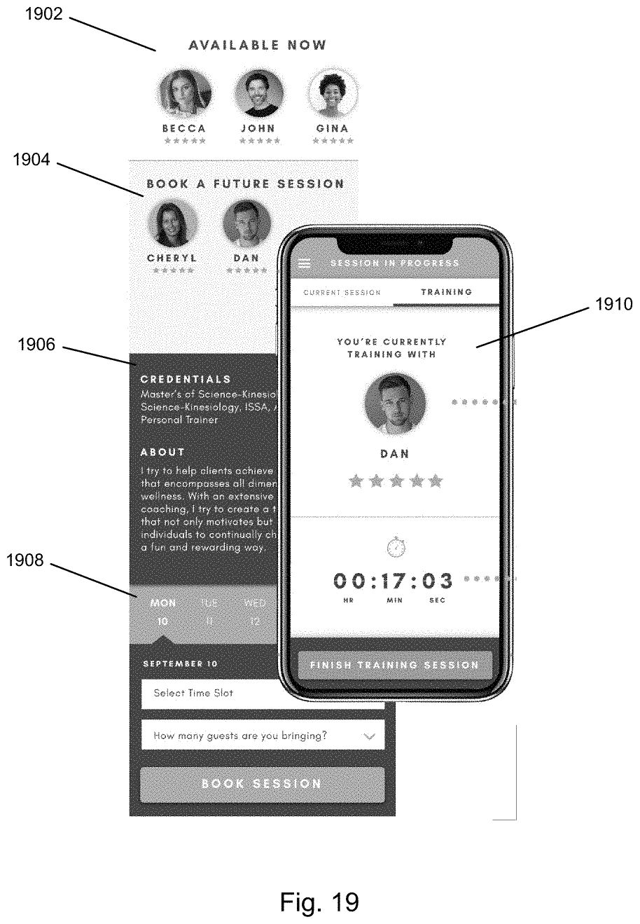

FIG. 19 presents exemplary personal training interfaces according to an embodiment of the present invention. In addition to gaining access to a facility, a user may use a client device to book in-facility training sessions with trainers that are available now 1902 and/or book a future session 1904 with trainers. Trainer profile information 1906 including credentials and reviews may be viewed by the user. A scheduling tool 1908 may also be provided to the user to schedule sessions with any trainer at an available time slot for current or future sessions.

A trainer-side application 1910 may be executed on a client device of a trainer and may be synchronized with a client device of a trainee. A facility session may be tracked alongside training time and data. Data and post-workout capture may be maintained by the facilities management server and used to track a regimen followed by the trainee user to capture all relevant data. Trainers may accept as many trainees as the trainee user wishes to bring, and keep track of analytics through the trainer-side application 1910.

According to one embodiment, virtual reality and/or augmented reality hardware and software may be used to generate tours of facilities so that facilities can pre-sell memberships as they open new facilities or before the facilities open. In another embodiment, virtual reality and/or augmented technology may be implemented at given facilities for taking classes at the facilities. For example, a user may enter a classroom and take a class with a celebrity, professional athlete, etc., and provide an experience that simulates having people around the user taking the class with the user. Additionally, virtual reality and/or augmented may be used to train with personal trainers, celebrities, or other figures that are aspirational.

FIGS. 1 through 19 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system for managing facility access and user presence tracking, the system comprising:
a facilities management server configured to:
authenticate a client device over a communications network, the client device initiating the authentication by scanning a scan code at a terminal of a facility; and
transmit instructions to the terminal to check-in a user of the client device and allow the user access to the facility.
